(19) United States
(12) Patent Application Publication
(10) Pub. No.: US 2007/0121990 A1
(43) Pub. Date: May 31, 2007

(54) Speaker device

(75) Inventor: Takeshi Iwata, Yamagata (JP)

Correspondence Address: ARENT FOX PLLC, 1050 CONNECTICUT AVENUE, N.W., SUITE 400, WASHINGTON, DC, 20036, US

(73) Assignees: PIONEER CORPORATION; TOHOKU PIONEER CORPORATION

(21) Appl. No.: 11/494,622

(22) Filed: Jul. 28, 2006

(30) Foreign Application Priority Data
Jul. 29, 2005 (JP) 2005-221811

(51) Int. Cl. H04R 1/02

(52) U.S. Cl. 381/395

(57) ABSTRACT

It is an object of the present invention to provide an improved speaker device capable of restricting a wiring position of a speaker cord using a simple structure, reducing the number of parts necessary for use in speaker cord fixation. The speaker device of the present invention has a speaker unit, a frame structure having an attachment section for attaching the speaker unit to an attachment base. The frame structure has an attachment section for attaching the speaker unit to an attachment base, a fixing section (wiring position restricting means) for restricting the wiring position of the speaker cord led out from the speaker unit, on the frame structure by virtue of a damper member. The frame structure and the wiring position restricting means are formed by an identical material such as resin or metal. Therefore, it is possible to restrict the wiring position of the speaker cord using a simpler structure.

### BACKGROUND OF THE INVENTION

The present invention relates to a speaker device.

The present application claims priority from Japanese Application No. 2005-221811, the disclosure of which is incorporated herein by reference.

With regard to a conventional speaker device, a speaker terminal section electrically connected to a voice coil is formed in a speaker frame or the like, while a speaker cord is led out from the speaker terminal section. In order for the speaker cord not to get caught on other parts so as to avoid an unnecessary external force which can damage the speaker terminal section or the like, such a speaker cord is usually fixed in the speaker frame or the like. In fact, there are various methods which can be used to fix a speaker cord.

For example, Japanese Unexamined Patent Application Publication No. 6-44288 has disclosed a speaker device in which a speaker cord is fixed in a retaining section formed in a speaker frame by means of a string-like clamper member.

Moreover, a conventional speaker device 1J shown in FIGS. 1A and 1B usually includes an attachment bracket 20J provided as an additional item for attaching a speaker 100J to an attachment base. Such attachment bracket 20J has a cord clamping section 21J, so that a speaker cord L1 is tightly attached and thus fixed to the cord clamping section 21J by means of a damper member 22J.

With the speaker device mentioned above, although the speaker cord fixing means is formed in the speaker frame or the attachment bracket, it has been desired to provide a speaker device which can restrict a wiring position of a speaker cord using a simplified structure. Further, in order to reduce a cost and improve an operating efficiency when manufacturing a speaker device, it is desired to reduce the number of parts which are necessary for use in speaker cord fixation. Moreover, in order to improve an operating efficiency in speaker manufacturing, it is desired to produce a speaker device capable of easily improving an operating efficiency in fixing or detaching a speaker cord.

### SUMMARY OF THE INVENTION

The present invention is to solve the aforementioned problem and makes this as one of its tasks. It is an object of the present invention to provide an improved speaker device capable of restricting a wiring position of a speaker cord using a simple structure, reducing the number of parts which are necessary for use in speaker cord fixation. Another object of the invention is to provide an improved speaker device capable of improving an operating efficiency when fixing and detaching a speaker cord.

In order to achieve the above objects, the present invention is characterized by at least the following aspect.

According to the present invention, there is provided a speaker device including a speaker unit and a frame structure having an attachment section for attaching the speaker unit to an attachment base. In particular, the frame structure has wiring position restricting means for restricting a wiring position of a speaker cord led out from the speaker unit on the frame structure. Further, the frame structure and the wiring position restricting means are formed into an integral body using an identical material.

### BRIEF DESCRIPTION OF THE DRAWINGS

These and other objects and advantages of the present invention will become clear from the following description with reference to the accompanying drawings, wherein:

FIGS. 1A and 1B are explanatory views showing a conventional speaker device, in which FIG. 1A is a side view and FIG. 1B is a perspective view showing an operation for attaching the conventional speaker device;

FIG. 2 is a front view showing a speaker device formed according to a first embodiment of the present invention;

FIG. 3 is an explanatory view showing a backside of the speaker device illustrated in FIG. 2;

FIG. 4 is a side view of the speaker device illustrated in FIG. 2;

FIG. 5 is a perspective view of the speaker device illustrated in FIG. 2;

FIG. 6 is an explanatory view showing a wiring position of a speaker cord of the speaker device illustrated in FIG. 2;

FIGS. 7A, 7B, and 7C are perspective views showing several different types of cord fixing sections of the speaker device of the present invention, in which FIG. 7A shows a first example, FIG. 7B shows a second example, and FIG. 7C shows a third example;

FIG. 8 is an enlarged view showing an area around a fixing section 202, illustrating an operation of fixing the speaker cord of the speaker device shown in FIGS. 2 to 6;

FIGS. 9A, 9B, and 9C are sectional views each taken along A-A line in FIG. 8, showing an operation of fixing the speaker cord at the fixing section 202;

FIG. 10 is an explanatory view showing a conventional speaker device not having a convex portion 202d at an end of the fixing section 202;

FIG. 11 is a front view showing in detail a speaker device la formed according to a second embodiment of the present invention;

FIG. 12 is an explanatory view showing a backside of the speaker device la illustrated in FIG. 11;

FIG. 13 is a sectional view taken along A-A line in FIG. 11;

FIG. 14 is a perspective view showing a backside of the speaker device la illustrated in FIG. 11;

FIG. 15 is an explanatory view showing a conventional speaker device not having any wiring position restricting means;

FIG. 16 is an enlarged view showing an area around a restricting section shown in FIG. 12 and FIG. 16; and

FIG. 17 is a side view showing the restricting section illustrated in FIG. 16.

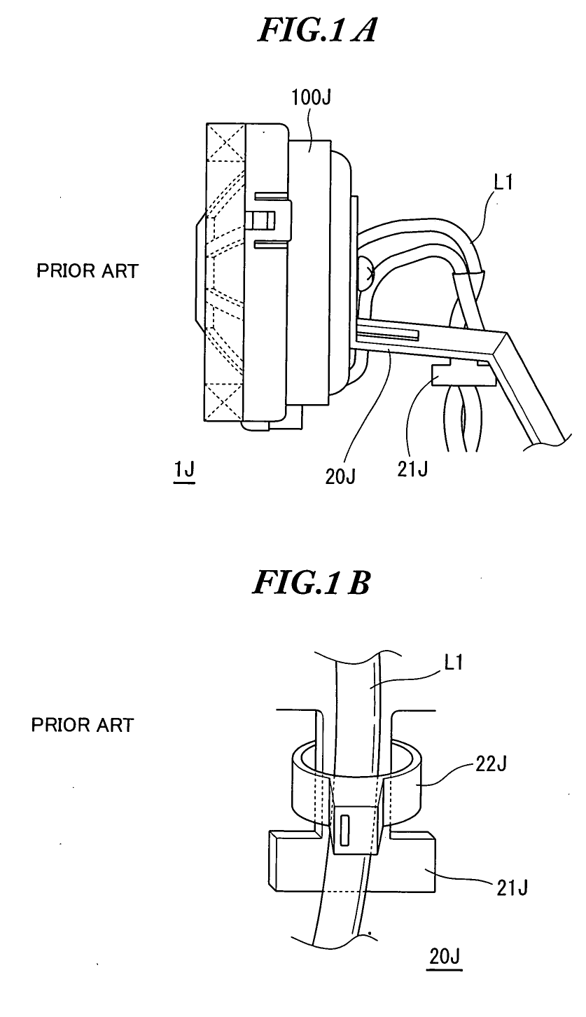

### DETAILED DESCRIPTION OF THE PREFERRED EMBODIMENTS

The speaker device according to one embodiment of the present invention includes a speaker unit, a frame structure having an attachment section for attaching the speaker unit to an attachment base. The frame structure has an attachment section for attaching the speaker unit to an attachment base, wiring position restricting means for restricting the wiring position of a speaker cord led out from the speaker unit, on the frame structure by virtue of a damper member. The frame structure and the wiring position restricting means are formed by an identical material such as resin or metal.

Since the speaker device having the afore-mentioned structure is provided with wiring position restricting means consisting of a resin or a metal and formed integrally with the frame structure, it becomes possible to restrict the wiring position of the speaker cord using a simplified structure, and to reduce the number of parts necessary for use in speaker cord fixation.

In the following, description will be given to explain an embodiment of the present invention with reference to the accompanying drawings.

### First Embodiment

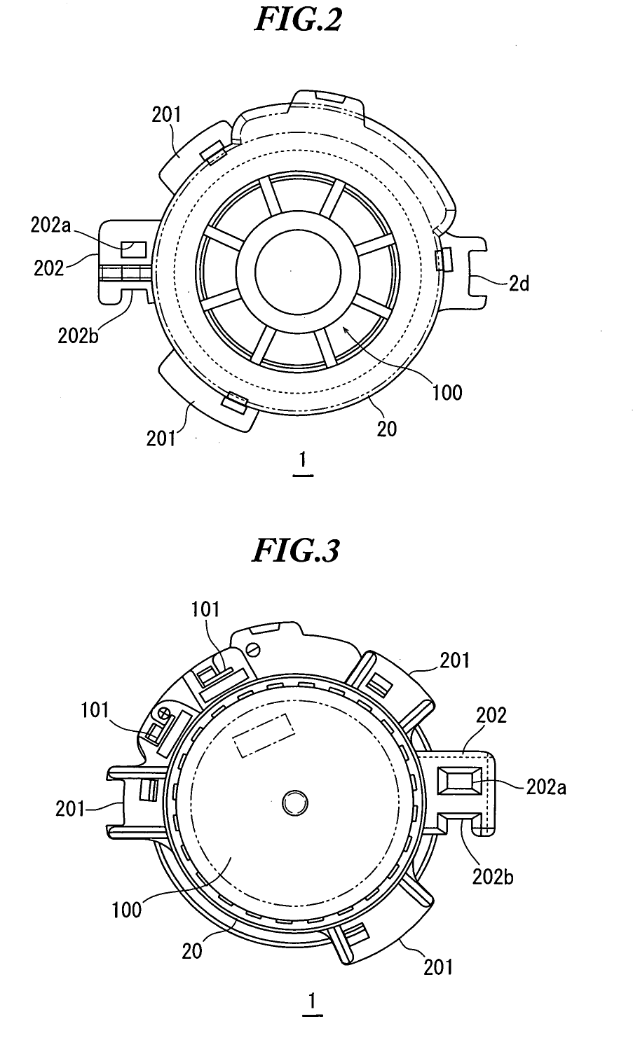

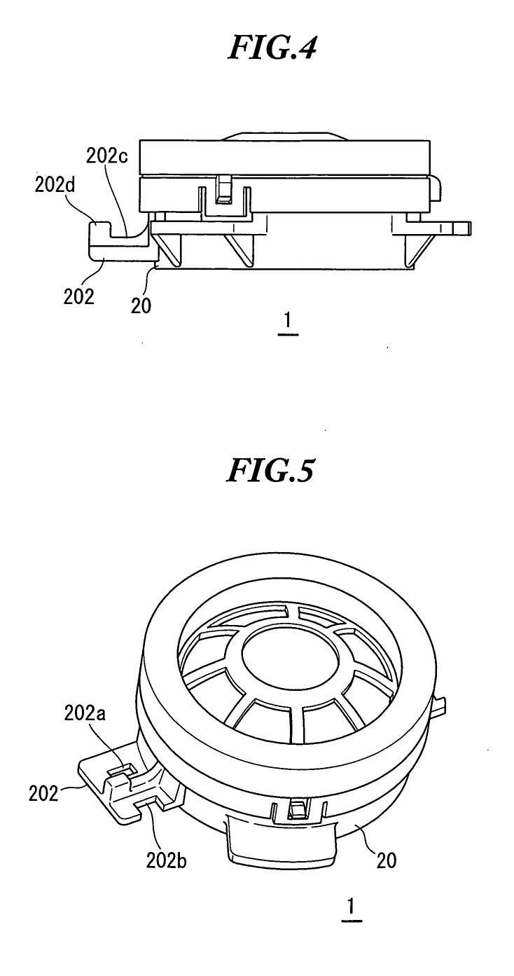

FIG. 2 is an explanatory view showing a speaker device formed according to a first embodiment of the present invention. In detail, FIG. 2 is a front view of the speaker device 1. FIG. 3 is an explanatory view showing a backside of the speaker device illustrated in FIG. 2. FIG. 4 is a side view of the speaker device shown in FIG. 2. FIG. 5 is a perspective view of the speaker device shown in FIG. 2. Although the following description is based on a dome type speaker device, this should not form any limitation to the present invention. In fact, the present invention can be applied to various other types of speaker devices including a cone type, a horn type, and a flat type or the like. Moreover, even with a dome type speaker unit, there can be various types of configurations and the present invention should not be limited to the following description. Besides, although the following description is based on a vehicle speaker device, this should not form any limitation to the present invention, either. In fact, the present invention can be applied to any speaker devices to be attached to any desired attachment bases.

As shown in FIGS. 2 to 5, the speaker device 1 of the present embodiment of the present invention has a speaker unit 100 and a speaker frame structure 20.

The speaker unit 100 comprises: a magnetic circuit consisting of a plate, a permanent magnet, and a yoke; a voice coil positioned in a magnetic gap formed between the plate and the yoke and driven by an electric signal supplied hereto; a voice-coil bobbin wound around by the voice coil; and a diaphragm. Moreover, as shown in FIG. 3, a speaker terminal section 101 connected with the voice coil is formed on the backside of the speaker unit 100.

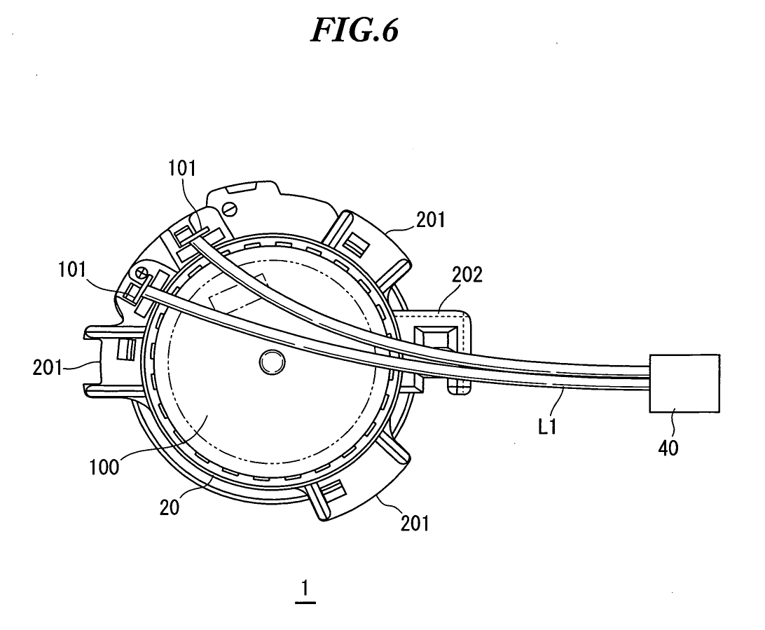

FIG. 6 is an explanatory view showing a wiring position of a speaker cord of the speaker device illustrated in FIG. 2. As shown in FIG. 6, there have been arranged a speaker cord (electrically conductive wire) L1 in a manner such that one end of the cord is electrically connected to the speaker terminal section 101 while the other end thereof is connected to a connector terminal 40. When an electrical signal is supplied to the voice coil through the speaker terminal section 101, the voice-coil bobbin will be driven, thereby effecting a vibration of a vibrating member such as the diaphragm.

The frame structure 20 may be formed of a predetermined material such as resin or metal. In the present embodiment, the frame structure 20 is formed of a resin material. As shown in FIGS. 2-5, the frame structure 20 is formed to cover at least the side wall of the speaker unit 100. In detail, the frame structure 20 has an attachment section 201 and a speaker cord fixing section 202. Here, the cord fixing section 202 serves as an embodiment of wiring position restricting means or speaker cord fixing means in the present invention.

The attachment section 201 is a convex portion formed on the side wall of the frame structure 20 for attaching the speaker unit to an attachment base. The cord fixing section 202 serves as wiring position restricting means for restricting the wiring position of the speaker cord L1 led out from the speaker unit, with respect to the frame structure 20. In more detail, as shown in FIGS. 2 to 5, the cord fixing section 202 which is protruding outwardly is formed on the side wall of the frame structure 20, while the speaker cord L1 is fixed on the fixing section 202. In the present embodiment, the speaker cord L1 is tightly fixed on the fixing section 202 by means of an attachment member such as a string-like clamper. In practice, such fixing section 202 may be formed into a predetermined shape like a plate or a rod. In the present embodiment, the fixing section 202 is a plate-like member formed on the side wall of the frame-structure 20. Further, such fixing section 202 has drop-preventing means for preventing the damper from dropping down. For example, as shown in FIGS. 2 to 5, the fixing section 202 has a through hole 202a formed in the central portion thereof, a notch 202b formed in an edge portion of the fixing section, a reinforcing rib 202c formed between the through hole 202a and the notch 202b, and a convex portion 202d formed near an edge of the fixing section 202 and serving as the drop-preventing means. Namely, the fixing section 202 has a generally L-shaped member for preventing the dropping of the clamper. In fact, the fixing section 202 can have any desired shape, provided that it can be engaged by the damper having the above-described configuration, so that the damper will not drop from the fixing section 202.

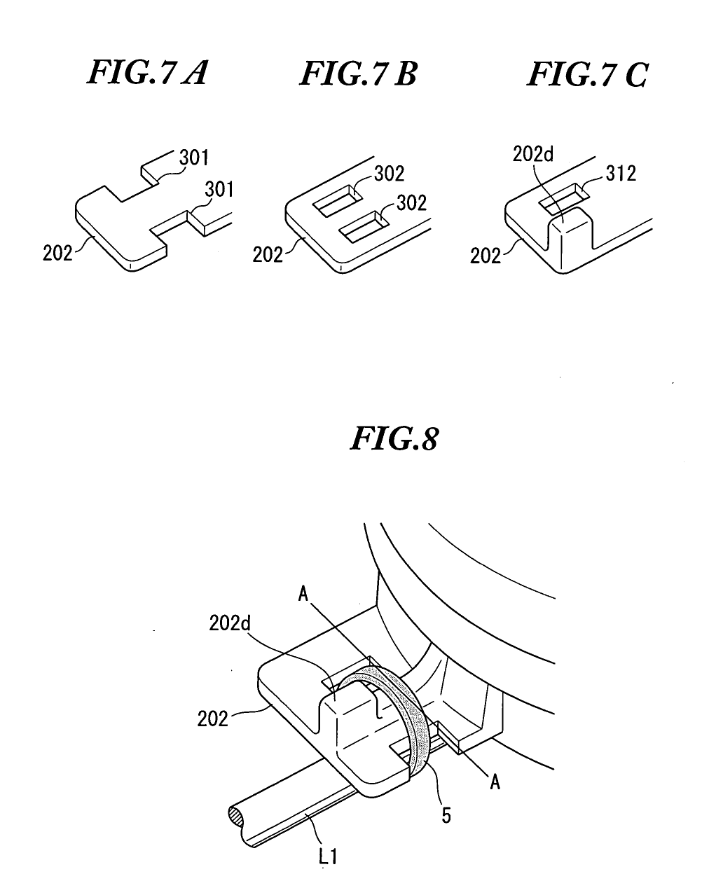

FIGS. 7A to 7C are perspective views showing several examples of a fixing section of a speaker device formed according to the present invention. In detail, FIG. 7A shows a first example, FIG. 7B shows a second example, and FIG. 7C shows a third example. As shown in FIG. 7A, the fixing section 202 is allowed to have notches 301 which allow an engagement of the damper member on both edge portions of the plate-like fixing section 202. Alternatively, as shown in FIG. 7B, the fixing section 202 is allowed to have two through holes 302 which allow an insertion of the damper member near the center of the plate-like fixing section 202. As a third example, as shown in FIG. 7C, the fixing section 202 is allowed to have a through hole 302 near the central portion thereof and a drop-preventing convex portion 202d on a corner of the plate-like fixing section 202.

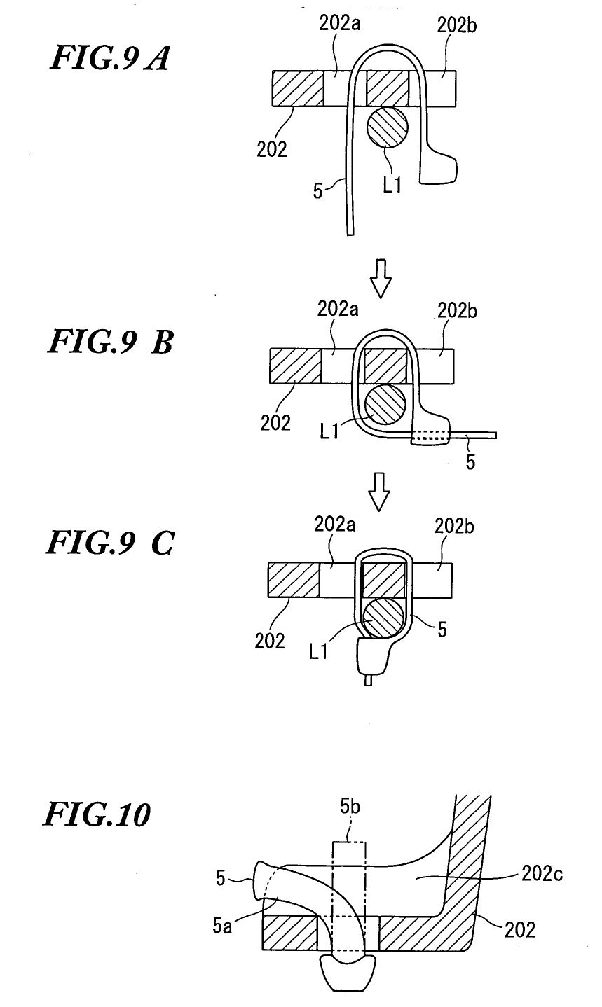

FIG. 8 is an explanatory perspective view showing an operation for fixing a speaker cord of the speaker device illustrated in FIGS. 2 to 6. Actually, FIG. 8 is an enlarged view showing an area around the fixing section 202. FIGS. 9A to 9C are explanatory sectional views taken along A-A line in FIG. 8, showing an operation for fixing a speaker cord in the fixing section 202. Next, description will be given to explain an operation for fixing the speaker cord in the fixing section 202, with reference to FIGS. 2 to 6, 8 and 9.

At first, the speaker cord L1 led out from the speaker terminal section 101 formed on the backside of the speaker unit 100 is placed near the backside of the fixing section 202. Preferably, the speaker cord is disposed in a manner such that it is in contact with the backside of the fixing section 202. Then, the string-like damper member 5 is inserted through the through holes 202a, thereby fixing the speaker cord L1 in the fixing section 202 in a manner shown in FIGS. 8, 9A to 9C by virtue of the damper 5 fitting in the notch 202b and the through hole 202a.

At this time, as shown in FIG. 10, if no such convex portion 202d is formed at an edge of the fixing section 202, there will be a possibility that the clamper member 5 will drop down. To avoid such a possibility, the fixing section 202 of the present invention has a convex portion 202d having a height which is larger than the thickness of the clamper member 5, as shown in FIGS. 4 and 5. In this way, it is possible to prevent the clamper member 5 from dropping down. Besides, if no such convex portion 202d is formed at an edge of the fixing section 202, there will be a possibility that the damper member 5 will be undesirably fixed in a bent state 5a near an edge of the fixing section 202, as shown in FIG. 10. On the other hand, when the damper member 5 is returned to its normal position 5b, a desired cord fixation will get loosed so that it becomes impossible to exactly fix the speaker cord. Such problem has been solved by virtue of the convex portion 202d formed at an edge of the fixing section 202 in the present embodiment of the present invention, as shown in FIGS. 4 and 5.

As describe above, the frame structure 20 has an attachment section 201 for attaching the speaker unit 100 to an attachment base, and a fixing section 202 (wiring position restricting means) for fixing the wiring position of the speaker cord L1 led out from the speaker unit 100, using the damper member 5 and thus effecting the fixation with respect to the frame structure 20, with the frame structure and the wiring position restricting means formed by an identical material such as a resin or a metal. In this way, it is possible to restrict the wiring position of the speaker cord with a simpler configuration.

In a conventional speaker device, it is necessary to prepare, as an additional item, an attachment bracket having formed thereon a speaker cord fixing portion and to attach the bracket to the speaker unit. In the speaker device 1 of the present invention, since the frame structure 20 and the fixing section 202 are formed into an integral body, it is possible to reduce the number of parts necessary for fixing the speaker cord.

Moreover, since the fixing section 202 protruding outwardly is formed on the side wall of the frame structure 20, and since the speaker cord L1 led out from the speaker unit 100 is fixed at the fixing section by virtue of the clamper member 5, it is possible to improve an operating efficiency when fixing the speaker cord. Besides, using the damper member 5 which is easily detachable, it is possible to improve an operating efficiency when the speaker cord L1 is being removed.

### Second Embodiment

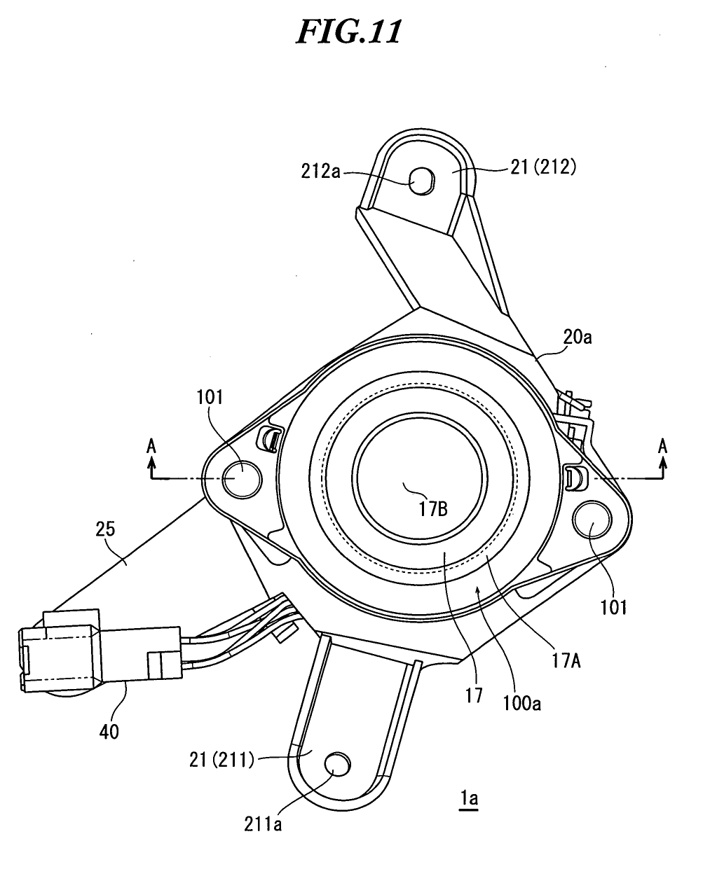

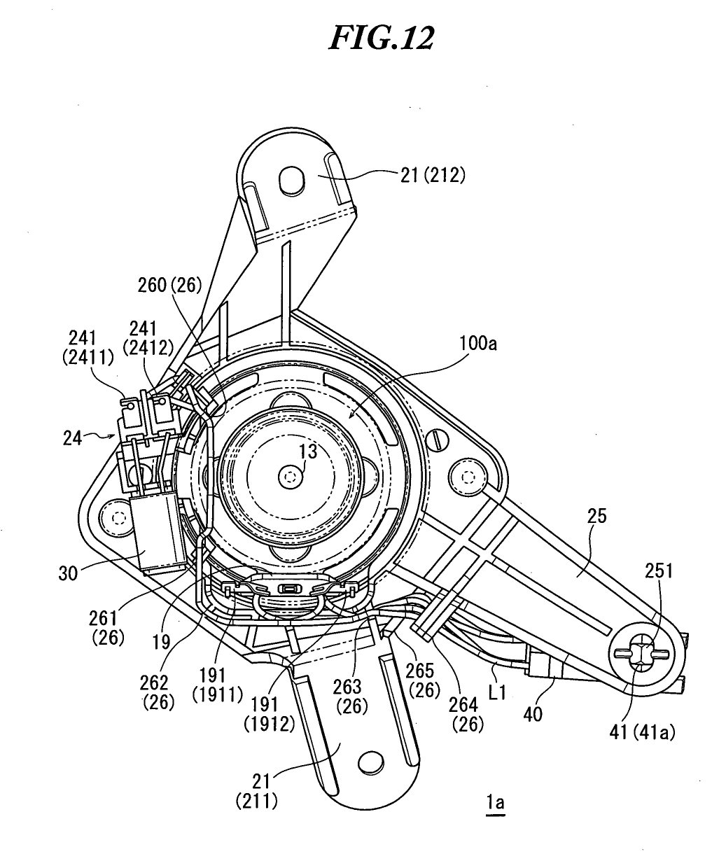

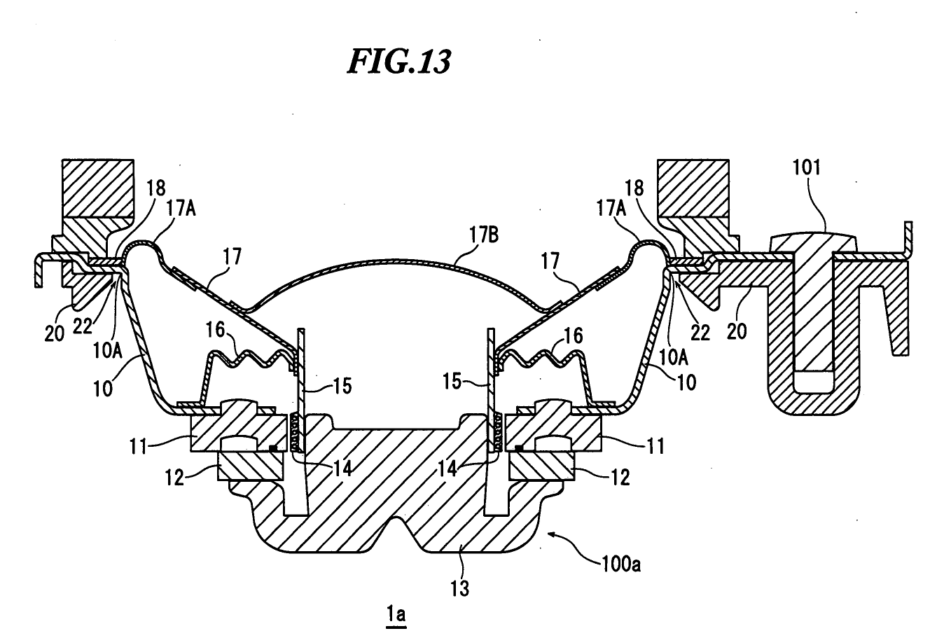

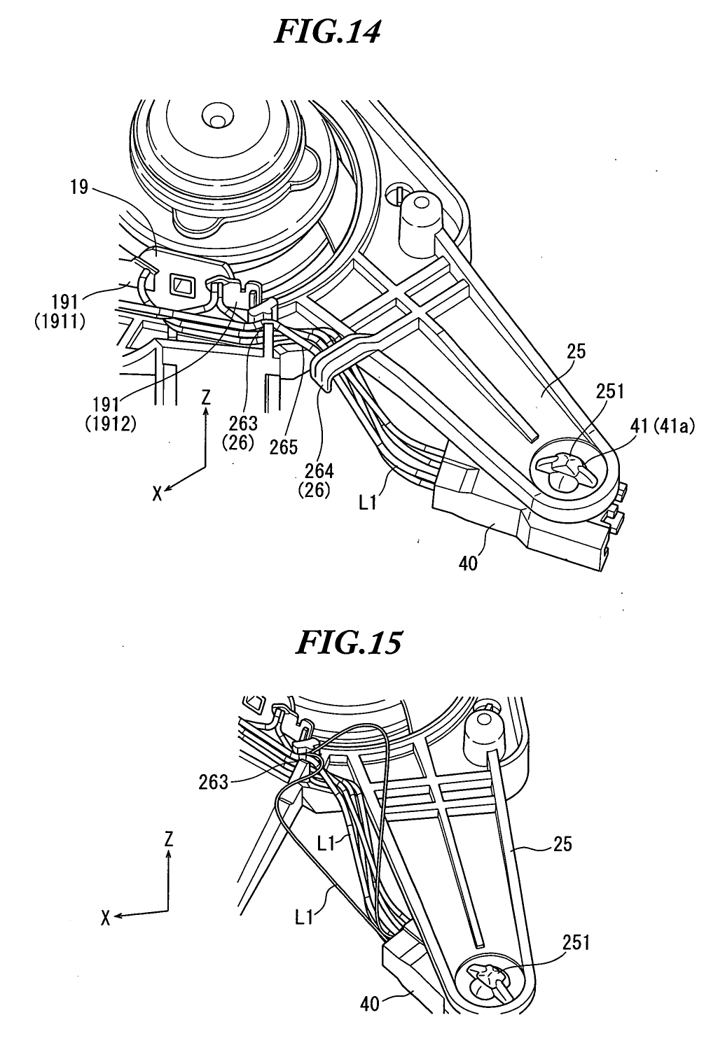

FIG. 11 is an explanatory front view showing a speaker device la formed according to a second embodiment of the present invention. FIG. 12 is a view showing a backside of the speaker device illustrated in FIG. 11. FIG. 13 is a sectional view taken along A-A line in FIG. 11. FIG. 14 is a perspective view showing a backside of the speaker device la illustrated in FIG. 12. Here, although the following description is given to explain a cone type speaker device, this should not form any limitation to the present invention. Further, even with regard to a cone type speaker device, the present invention should not be limited to a specific structure described below.

As shown in FIGS. 11 to 14, the speaker device la according to the present embodiment has a speaker unit 100a and a speaker frame 20a. The speaker unit 100a comprises: a magnetic circuit consisting of a speaker frame 10, a plate 11 attached to the bottom of the speaker frame 10, a permanent magnet 12, and a yoke 13; a voice coil 14 positioned in a gap formed between the plate 11 and the yoke 13 and driven by an electric signal supplied hereto; a voice-coil bobbin 15 wound around by the voice coil 14; a damper 16 supporting the voice-coil bobbin 15 on the speaker frame 10; a diaphragm 17 having an inner perimeter supported by the voice-coil bobbin 15 and an outer perimeter supported through an edge portion 17A of the diaphragm 17 by the outer periphery 10A of the speaker frame 10; and a dust cap 17B provided on the central portion of the diaphragm 17. The outer periphery of the edge portion 17A is air-tightly attached to the outer periphery 10A of the speaker frame 10 by means of a gasket 18. Further, the voice coil 14 is formed by wiring around the voice coil bobbin 15. Such a wiring is connected, by way of a flexible wire, to a speaker terminal section 191 on a speaker terminal board 19 provided on the backside of the speaker frame 10. In this way, when an electric signal is supplied to the voice coil 14 through the speaker terminal section 191, the voice coil will be driven, thereby causing a vibration of the diaphragm 17, the damper 16, and the like.

The frame structure 20 is formed by a material which may be resin, metal or the like. In the present embodiment, the frame structure 20 is formed by a resin. As shown in FIGS. 11 to 14, the frame structure 20 is formed along the outer periphery of the speaker frame 10 of the speaker unit 100a. In detail, the frame structure 20 has attachment portions 21 and a speaker attaching hole (attachment hole) 22. The attachment portions 21 are used to attach the frame structure to an attachment base. Here, as shown in FIGS. 11 to 14, the attachment portions 21 include a plurality of arms 211 and 212 having holes 211a and 212a which allow an insertion of the fixing members such as screws for fixing the frame structure 20 on to an attachment base. The attachment hole 22 is an opening for fitting the speaker unit 100a, so that the speaker unit 100a can be fitted in the opening and fixed in the frame structure 20.

Moreover, as shown in FIGS. 12 and 14, the speaker device la is formed in a manner such that the speaker terminal board 19 mounting the speaker terminal section 191 is formed on the backside of the speaker frame 10, while the frame structure 20 is provided with an electronic element attachment section 24 near the attachment hole 22 for attaching an electronic element 30 which controls an electrical signal being inputted into the speaker unit 100a. In the present embodiment, the speaker terminal board 19 has a plurality of speaker terminal units 1911, 1912. Further, as shown in FIGS. 12 and 14, the electronic element attachment section 24 has an electrically conductive terminal section (metallic terminal section) 241 including two metallic terminals 2411 and 2412.

Moreover, the frame structure 20 has a cord fixing section for fixing a part of the speaker cord L1 led out from the speaker unit 100a at a predetermined position separated a predetermined distance from the speaker unit 100a. In detail, as shown in FIGS. 12 and 14, the frame structure 20 has a connector terminal attachment section 25 for fixing a connector terminal 40 formed at one end of the speaker cord L1 led out from the speaker unit 100a at a position separated a predetermined distance from the speaker unit 100a. The connector terminal attachment section 25 of the present embodiment is a plate-like member having a longitudinal portion arranged in a predetermined direction with respect to the speaker unit 100a and having a predetermined length. An engagement hole 251 formed near one end of the connector terminal attachment section 25 is engaged by an engaging portion 41 formed at one end of the connector terminal 40, thereby fixing the connector terminal 40 in the frame structure 20. Moreover, the engaging portion 41 has a retaining member 41a serving as dislocation preventing means. As shown in FIGS. 12 and 14, the connector terminal 40, the speaker terminal section 191, and the electronic element 30 are suitably electrically connected by virtue of the speaker cord (electrically conductive wire) L1.

Moreover, the frame structure 20 has a relay section (wiring position restricting means) 26 for restricting the wiring position of the speaker cord L1. As shown in FIGS. 12 and 14, the relay section 26 of the present embodiment has a plurality of relay units 260 to 263. The first relay unit 260 is formed near the metallic terminal 241, the second and third relay units 261 and 262 are formed near the metallic terminal 241 and the speaker terminal section 191, and the fourth relay unit 263 is formed near the speaker terminal section 191, thereby respectively restricting the wiring position of the speaker cord L1. In more detail, grooves are formed in the first to fourth relay units 260 to 263 so that the speaker cord L1 may be engaged in these grooves so as to be fixed.

On the other hand, if there is no such means for restricting the wiring position as shown in FIG. 15, the speaker cord L1 disposed between the fourth relay unit 263 and the connector terminal 40 provided in the connector terminal attachment section 25 will be dislocated in z direction or x direction shown in FIG. 15, undesirably causing the speaker cord L1 to get in contact with other elements, causing a possibility that other elements can bite into these cords.

Moreover, as shown in FIGS. 12 and 14, the frame structure 20 of the present embodiment has wiring position restricting means for restricting the wiring position of the speaker cord L1 disposed between the fourth relay unit 263 and the connector terminal 40 provided in the connector terminal attachment section 25. In more detail, restricting units 264 and 265 are provided between the speaker unit 100a and the connector terminal 40 fixed in the connector terminal attachment section 25 for restricting the wiring position in a direction generally perpendicular to the longitudinal direction of the speaker cord L1. The restricting units 264 and 265 are positioned at a predetermined interval between the speaker unit 100a and the connector terminal 40 fixed in the connector terminal attachment section 25, so as to restrict the wiring position of the speaker cord L1 in mutually opposite directions which are all generally perpendicular to the longitudinal direction of the speaker cord L1.

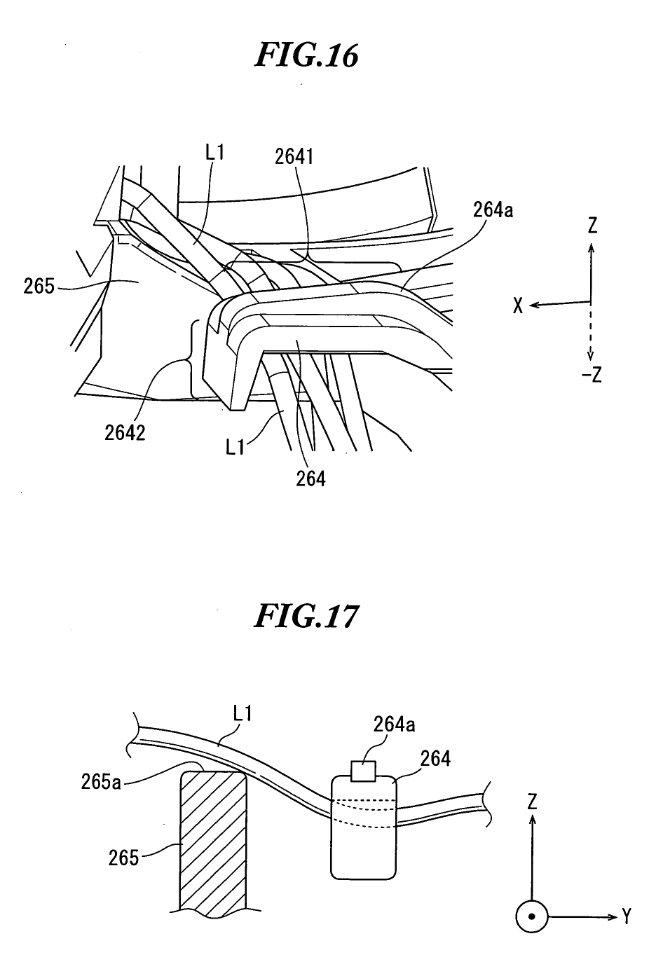

FIG. 16 is an enlarged view showing an area around the restricting sections which have been shown in FIGS. 12 and 14. FIG. 17 is a side view showing the restricting sections illustrated in FIG. 16. As shown, the frame structure 20 has an upwardly protruding (z direction) restricting section 265 located near the root portion of the connector terminal attachment section 25, and an outwardly protruding L-shaped restricting section 264 located on the side wall of the connector terminal attachment section 25 at a position separated a predetermined distance from the restricting section 265.

As shown in FIG. 16, the restricting section 264 includes a convex restricting portion 2641 protruding in an outward direction (x direction) from the side wall of the connector terminal attachment section 25, and another restricting portion 2642 protruding in a downward direction (z direction) from an end of the restricting portion 2641. Preferably, the restricting portion 2641 is formed at a position which is lower than or substantially equal to the height (z direction) of an upper surface portion 265a of the convex restricting portion 265.

Next, description will be given to explain in detail an example in which the speaker cord L1 is attached by wiring to the frame structure 20 when manufacturing a speaker device. Namely, at first, the engaging portion 41 of the connector terminal 40 is engaged in the engagement hole 251 of the connector terminal attachment section 25, so that the connector terminal 40 itself can be attached to an end of the connector terminal attachment section 25. In this way, the speaker cord L1 can be led along the side wall of the connector terminal attachment section 25, passing through the inner side of a bent portion of the L-shaped restricting section 264, so as to be engaged in the fourth relay unit 263 through the upper surface 265a of the restricting section 265. For example, the speaker cord L1 can be electrically connected to the speaker terminal section 191 from the fourth relay unit 263, or to the metallic terminal 241 through the third relay unit 262, the second relay unit 261 and the first relay unit 260. However, a wiring method should not be limited to the above-described manner and it is possible to arrange by wiring the speaker cord L1 in an inversed order of the above-described manner.

As mentioned above, the restricting portion 2641 will downwardly (-z direction) press the speaker cord L1 led out from the speaker terminal section 191 of the speaker unit 100a, passing through the fourth relay unit 263 and the upper surface 265a of the convex restricting section 265, and arriving at the connector terminal 40 located near the end of the connector terminal attachment section 25. In this way, it is possible to restrict the speaker cord L1 in an upward direction. Moreover, by virtue of the convex restricting section 265 and the L-shaped restricting section 264 separated a predetermined distance from each other, it is possible to restrict the wiring position of the speaker cord L1 in mutually opposite directions (z direction), thereby making it possible to exactly restrict the wiring position of the speaker cord L1 in z direction. Further, the second restricting portion 2642 will restrict the wiring position in x direction on the side wall of the connector terminal attachment section 25.

Moreover, since the restricting section 264 is formed into an L-shaped structure protruding on the side wall of the connector terminal attachment section 25 and since such restricting section 264 can restrict the wiring position of the speaker cord L1 on the inner side of the bent portion of the L-shaped structure, it is possible to restrict the wiring position in both x direction and z direction, as shown in FIG. 16. In this way, it is possible to prevent a dislocation of the speaker cord L1 which can make the speaker cord L1 to get caught in other elements and thus apply an undesired external force to them, thereby preventing a possible damage to some essential elements of the speaker terminal section or the like.

Moreover, by setting the restricting portions 2641 and 2642 of the L-shaped restricting section 264 at appropriate lengths, it is possible to fix a thick speaker cord L1 or a plurality of speaker cords L1 at one position so as to restrict the wiring positions of the speaker cords.

The present invention is by no means to be limited to the above-described embodiments and it is possible to set a combination containing two or more of the above-described embodiments. Further, although the above-described embodiments are based on a vehicle speaker device, this should not form any limitation to the present invention. Moreover, although the above-described embodiments are based on a round speaker unit, the present invention can also be applied to speaker devices of any other shapes. In addition, although the above description has been given to explain a string-like clamper member 5, a damper member for use in the present invention can also have any other desired shapes.

As described above, the speaker device 1(1a) of the present invention has a speaker unit 100 (100a) , a frame structure 20 having an attachment section for attaching the speaker unit 100 (100a) to an attachment base. The frame structure 20 has an attachment section 201 (21) for attaching the speaker unit 100 (100a) to an attachment base, a fixing section 202 (wiring position restricting means) for fixing the wiring position of the speaker cord L1 led out from the speaker unit 100 (100a) on the frame structure 20 by virtue of the damper member 5. The frame structure and the wiring position restricting means are formed by an identical material such as resin or metal. Therefore, it is possible to restrict the wiring position of the speaker cord using only a simplified structure.

Moreover, since the fixing section 202 is protruding outwardly and formed on the side wall of the frame structure 20, and since the speaker cord L1 led out from the speaker unit 100 (100a) is fixed in the fixing section 202 by virtue of the damper member 5, it is possible to obtain an improved efficiency during an operation of fixing or detaching the speaker cord L1.

Moreover, the frame structure 20 has a cord fixing section for fixing a part of speaker cord L1 led out from the speaker unit 100a at a predetermined position separated a predetermined distance from the speaker unit 100a. In more detail, the frame structure 20 has a connector terminal attachment section 25 for fixing a connector terminal 40 formed at one end of the speaker cord L1 extending from the speaker unit 100, at a predetermined position separated a predetermined distance from the speaker unit 100a. The frame structure 20 also has restricting sections 264, 265 located between the speaker unit 100 and the connector terminal 40 fixed in the connector terminal attachment section 25 for restricting the wiring position in a direction generally perpendicular to the longitudinal direction of the speaker cord L1. In this way, it is possible to exactly restrict the wiring position of the speaker cord L1 using only a simple structure.

While there has been described what are at present considered to be preferred embodiments of the present invention, it will be understood that various modifications may be made thereto, and it is intended that the appended claims cover all such modifications as fall within the true spirit and scope of the invention.

What is claimed is:

1. A speaker device including a speaker unit and a frame structure having an attachment section for attaching the speaker unit to an attachment base,
wherein the frame structure has wiring position restricting means for restricting a wiring position of a speaker cord led out from the speaker unit on the frame structure,
wherein the frame structure and the wiring position restricting means are formed into an integral body using an identical material.

2. The speaker device according to claim 1, wherein the frame structure is formed at least of a resin material or a metal material.

3. The speaker device according to claim 1, wherein the wiring position restricting means has a speaker cord fixing section outwardly protruding from a side wall of the frame structure.

4. The speaker device according to claim 3, wherein the speaker cord is tightly fixed at the speaker cord fixing section by means of a string-like clamper member.

5. The speaker device according to claim 3, wherein the speaker cord fixing section has a drop preventing structure for preventing a drop-down of the clamper member.

6. The speaker device according to claim 3, wherein the speaker cord fixing section has notches to be engaged by the damper member.

7. The speaker device according to claim 3, wherein the speaker cord fixing section has through holes allowing the damper member to insert therethrough.

8. The speaker device according to claim 3, wherein the speaker cord fixing section has a generally L-shaped portion formed near an end thereof for preventing a drop-down of the damper member.

9. The speaker device according to claim 3, wherein the speaker cord fixing section has a reinforcing rib.

10. The speaker device according to claim 1,
wherein the frame structure has a cord fixing section for fixing part of the speaker cord led out from the speaker unit at a predetermined position separated a predetermined distance from the speaker unit,
wherein the wiring position restricting means is formed between said predetermined position and the speaker unit for restricting the wiring position in a direction generally perpendicular to the longitudinal direction of the speaker cord.

11. The speaker device according to claim 1,
wherein the frame structure has a connector terminal attachment section for fixing a connector terminal formed at an end of the speaker cord led out from the speaker unit at a position separated a predetermined distance from the speaker unit,
wherein the wiring position restricting means is formed between the speaker unit and the connector terminal fixed in the connector terminal attachment section for restricting the wiring position in a direction generally perpendicular to the longitudinal direction of the speaker cord.

12. The speaker device according to claim 11,
wherein the wiring position restricting means includes first restricting means and second restricting means formed at a predetermined interval between the speaker unit and the connector terminal fixed in the connector terminal attachment section,
wherein the first restricting portion and the second restricting portion are provided to restrict the wiring position of the speaker cord in mutually opposite directions.

13. The speaker device according to claim 11, further comprising an L-shaped restricting means protruding on one side of the connector terminal attachment section,
wherein the restricting means is provided to restrict the wiring position of the speaker cord on an inner side of the L-shaped restricting means.

14. The speaker device according to claim 13, wherein the L-shaped restricting means has a reinforcing rib.
